(19) United States
(12) Patent Application Publication
(10) Pub. No.: US 2008/0180370 A1
(43) Pub. Date: Jul. 31, 2008

(54) Liquid Crystal Display and Driving Method Thereof

(75) Inventors: Hsueh-Ying Huang, Hsin-Chu (TW); Ming-Sheng Lai, Hsin-Chu (TW); Min-Feng Chiang, Hsin-Chu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORPORATION, Hsin-Chu (TW)

(21) Appl. No.: 11/776,618

(22) Filed: Jul. 12, 2007

(30) Foreign Application Priority Data
Jan. 25, 2007 (TW) 96102870

(51) Int. Cl. G09G 3/36

(52) U.S. Cl. 345/87

(57) ABSTRACT

A drive method for a pixel with a first and a second sub-pixel is provided. The method includes the steps of inputting a gray-level signal to the first and the second sub-pixel for forming a first and a second pixel voltage respectively, and providing a first signal and a second signal to the first and the second common electrode to change the first and a second pixel voltage respectively after scan lines located in a special region have been scanned.

### RELATED APPLICATIONS

This application claims priority to Taiwan Patent Application Serial Number 96102870, filed Jan. 25, 2007, which is herein incorporated by reference.

### FIELD OF THE INVENTION

The present invention relates to a driving method, and more particularly to a driving method for a liquid crystal display.

### BACKGROUND OF THE INVENTION

Liquid crystal displays have been used in various electronic devices. A Vertically Aligned Mode (VA mode) liquid crystal display is developed to provide a wider viewing range. When a user looks at an LCD in the VA mode from an oblique direction, the skin color of Asian people (light orange or pink) appears bluish or whitish. Such a phenomenon is called color shift or color wash out.

A Multi-Domain Vertically Aligned Mode (MVA mode) liquid crystal display was developed by Fujitsu in 1997 to provide a wider viewing range. In the MVA mode, a 160 degree view angle and a high response speed was achieved. However, when a user looks at this LCD from an oblique direction, the skin color of Asian people (light orange or pink) still appears bluish or whitish. Such a phenomenon is called color shift or color wash out.

The transmittance-voltage (T-V) characteristic of the MVA mode liquid crystal display is shown in FIG. 1. The vertical axis is the transmittance rate. The horizontal axis is the applied voltage. When the applied voltage is increased, the transmittance rate curve 101 in the normal direction is also increased. The transmittance changes monotonically as the applied voltage increases. The curve 102 represents the transmittance rate curve from the oblique direction, However, in the region 100, when the applied voltage is increased, the transmittance rate curve 102 is not increased. That is the reason why the color shifts.

A method is provided to improve the foregoing problem. According to the method, a pixel unit is divided into two sub pixels. The two sub pixels may generate two different T-V characteristics. By combining the two different T-V characteristics, a monotonic T-V characteristic can be realized. The line 201 in FIG. 2 shows the T-V characteristic of a sub-pixel. The line 202 in FIG. 2 shows the T-V characteristic of another sub-pixel. By combining the two different T-V characteristics of line 201 and line 202, a monotonic T-V characteristic can be realized, as shown by the line 203 in FIG. 2.

Therefore, a pixel unit and drive method thereof is required to resolve the foregoing problems.

### SUMMARY OF THE INVENTION

One object of the present invention is to provide a method for driving a liquid crystal display with a plurality of pixel units, wherein each pixel unit has two sub pixels.

Another object of the present invention is to provide a method for driving for a liquid crystal display with a plurality of pixel units, wherein each pixel unit has two different T-V characteristics.

Still another object of the present invention is to provide a method for driving a liquid crystal display with a plurality of pixel units, wherein each pixel unit has different optical characteristics and compensated to each other to ease the color shift phenomenon.

Accordingly, a drive method for driving a liquid crystal display is provided. The method is used to drive a pixel that includes two sub-pixels. The first sub-pixel includes a first transistor and a first storage capacitor coupling with the first common electrode and a second sub-pixel includes a second transistor and a second storage capacitor coupling with the second common electrode. The method comprises the following steps. In the first step a scan signal scans the scan lines sequentially to turn on the first transistors and the second transistors in the pixel units. In the second step gray-level signals are sent to the data lines to write the gray level signals to the first storage capacitors through the first transistors to form first pixel voltages and to write the gray level signals to the second storage capacitors through the second transistors to form second pixel voltages. In the last step a first signal is sent to the first common electrodes in the special region and a second signal is sent to the second common electrodes in the special region when the scan lines in the special region have been scanned, wherein the first signal changes the first pixel voltages through the first storage capacitors and the second signal changes the second pixel voltages through the second storage capacitors.

Accordingly, a pixel unit in the present invention is divided into two sub-pixels. Each sub-pixel includes a thin film transistor, a liquid crystal capacitor and a storage capacitor. The two sub-pixels may generate different pixel voltages to compensate for each other to release the color shift phenomenon.

### BRIEF DESCRIPTION OF THE DRAWINGS

The foregoing aspects and many of the attendant advantages of this invention are more readily appreciated and better understood by referencing the following detailed description, when taken in conjunction with the accompanying drawings, wherein:

FIGS. 1 and 2 illustrate the transmittance-voltage (T-V) characteristic of MVA mode liquid crystal display;

FIG. 3A illustrates a schematic diagram of a liquid crystal display.

FIG. 3B illustrates a top view of a liquid crystal display according to the first embodiment of the present invention.

FIG. 3C illustrates an enlarged schematic diagram of a pixel unit according to the present invention.

FIG. 4A illustrates drive waveforms for the common electrodes according to the first embodiment of the present invention.

FIG. 4B illustrates drive waveforms for the pixel units located in region 1 according to the first embodiment of the present invention.

FIG. 5A illustrates drive waveforms for the common electrodes according to the second embodiment of the present invention.

FIG. 5B illustrates drive waveforms for the pixel units located in region 1 according to the second embodiment of the present invention.

FIG. 6A illustrates drive waveforms for the common electrodes according to the third embodiment of the present invention.

FIG. 6B illustrates drive waveforms for the pixel units located in region 1 according to the third embodiment of the present invention.

FIG. 7A illustrates drive waveforms for the common electrodes according to the fifth embodiment of the present invention.

FIG. 7B illustrates drive waveforms for the pixel units located in region 1 according to the fifth embodiment of the present invention.

FIG. 8 illustrates a schematic diagram of a liquid crystal display using a dual driving technology.

FIG. 9A to FIG. 9E illustrate the waveforms for driving a liquid crystal display according to the present invention.

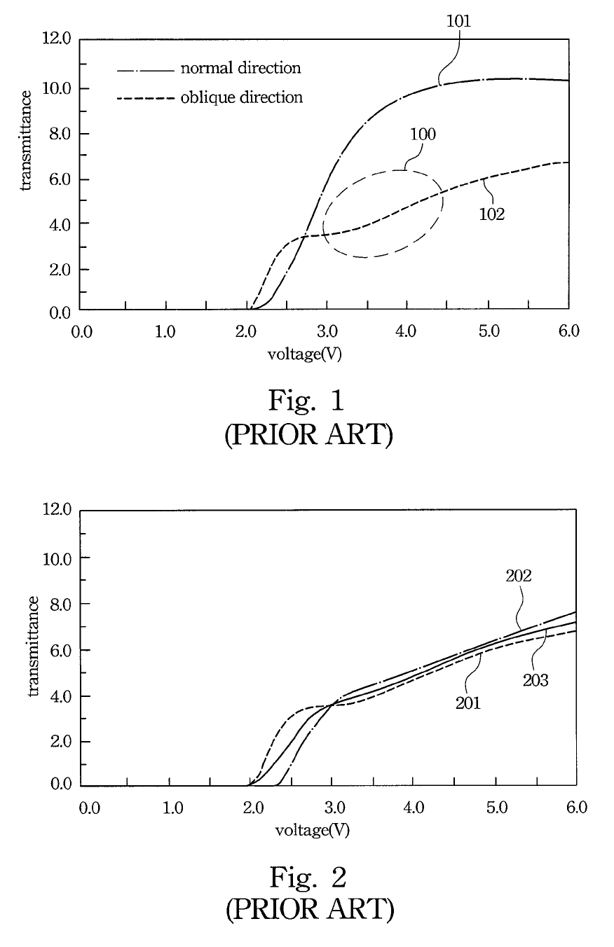

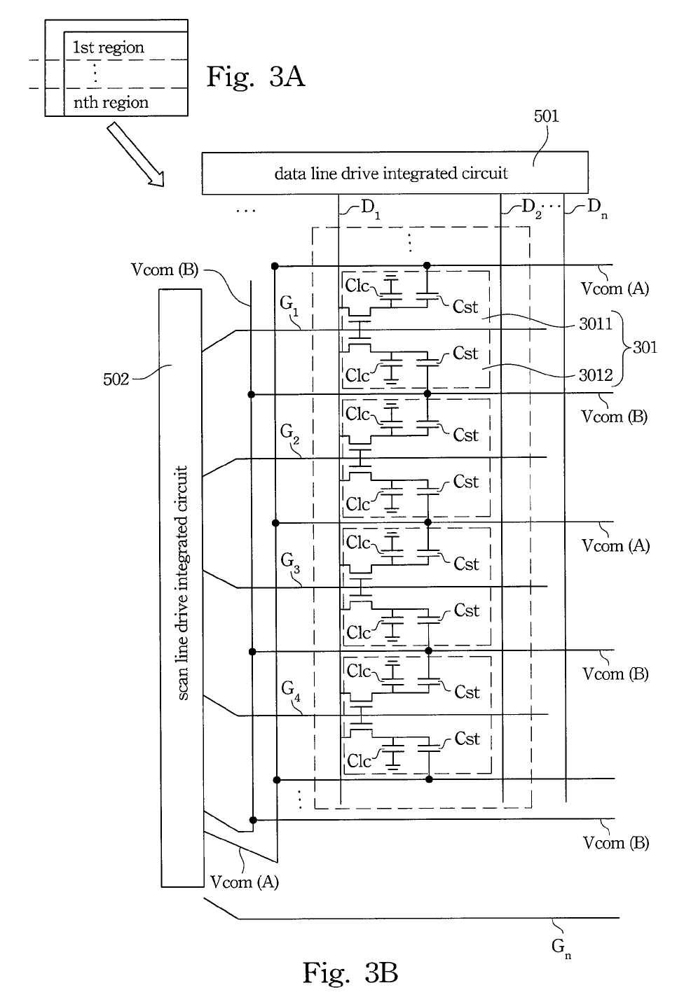

### DETAILED DESCRIPTION OF THE PREFERRED EMBODIMENT

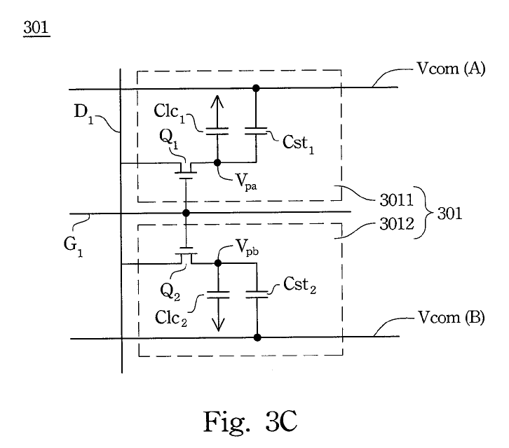

In one embodiment of the present invention, a pixel unit is divided into two sub-pixels. The voltage supplied from the individual common electrode drives the pixel electrode of each sub-pixel. Therefore, two different pixel voltages are formed in a pixel unit. Moreover, FIG. 3A illustrates a schematic diagram of a liquid crystal display. According to the embodiment, a panel is divided into N regions. The common electrodes located in different regions are preferably driven at different times. That is, the common electrodes located in same region are preferably driven at the same time. Therefore, a time difference exists in the driving voltages for the common electrodes located in different regions.

FIG. 3B illustrates a top view of a liquid crystal display according to the first embodiment of the present invention. Only the region 1 structure is illustrated in this figure. However, the rest may be deduced by analogy.

The Liquid crystal display is composed of data lines D1, D2, D3, Dn, scan lines G1, G2, G3, . . . , Gn and common electrodes. The data lines and the scan lines are perpendicular to each other. The scan lines and the common electrodes are alternatively arranged. A data line drive integrated circuit 501 controls the data lines D1, D2, D3, . . . , Dn. A scan line drive integrated circuit 502 controls the scan lines G1, G2, G3, . . . , Gn. In this embodiment, each region includes m scan lines. Therefore, region 1 includes the scan lines G1, G2, G3, . . . , Gm. Only four scan lines, G1, G2, G3 and G4, are illustrated in FIG. 3B. Moreover, a pixel unit is divided into two sub-pixels in the present invention. The voltage supplied from the individual common electrode to form different pixel voltages drive. Therefore, two different pixel voltages are formed in a pixel unit to ease the color shift phenomenon in the present invention.

FIG. 3C illustrates an enlarged diagram of a pixel unit 301. The pixel unit 301 is defined by the data line D1 and the scan line G1. Two common electrode lines V_{com}(A) and V_{com}(B) parallel to the scan lines are arranged in the two sides of the scan line G1. The pixel 301 is divided into two sub-pixels. The sub-pixel 3011 is located between the scan line G1 and the common electrode V_{com}(A). The sub pixel 3012 is located between the scan line G1 and the common electrode V_{com}(B).

The sub-pixel 3011 includes a transistor Q₁. According to the transistor Q₁, the gate electrode is connected to the scan line G1, the first source/drain electrode is connected to the data line D1 and the second source/drain electrode is connected to the pixel electrode Vₚₐ. The storage capacitor Cₛₜ₁ is composed of the pixel electrode Vₚₐ and the common electrode V_{com}(A). The liquid crystal capacitor C_{LC1} is composed of the pixel electrode Vₚₐ and the conductive electrode in the upper substrate (not shown).

The sub-pixel 3012 also includes a transistor Q₂. According to the transistor Q₂, the gate electrode is connected to the scan line G₁, the first source/drain electrode is connected to the data line D1 and the second source/drain electrode is connected to the pixel electrode V_{pb}. The storage capacitor Cₛₜ₂ is composed of the pixel electrode V_{pb} and the common electrode V_{com}(B). The liquid crystal capacitor C_{LC2} is composed of the pixel electrode V_{pb} and the conductive electrode in the upper substrate (not shown).

The transistors Q₁ and Q₂ act as switches to control the sub-pixel 3011 and the sub-pixel 3012 respectively. When a scan voltage is applied to the scan line G1, the transistors Q₁ and Q₂ are turned on. The data voltage in the data line D1 is transferred to the pixel electrode Vₚₐ and the pixel electrode V_{pb} and is written into the corresponding storage capacitor Cₛₜ₁, the storage capacitor Cₛₜ₂, the liquid crystal capacitor C_{LC1} and the liquid crystal capacitor C_{LC2}. In other words, the pixel electrode Vₚₐ and the pixel electrode V_{pb} both provide data voltage to the data line D1. According to the present invention, different driving voltages are provided to the common electrode V_{com}(A) and the common electrode V_{com}(B). By the coupling effect of the storage capacitor Cₛₜ₁ and the storage capacitor Cₛₜ₂, different pixel voltages are applied to the pixel electrode Vₚₐ and the pixel electrode V_{pb}. Combining the two pixel voltages in a pixel may ease the color shift phenomenon.

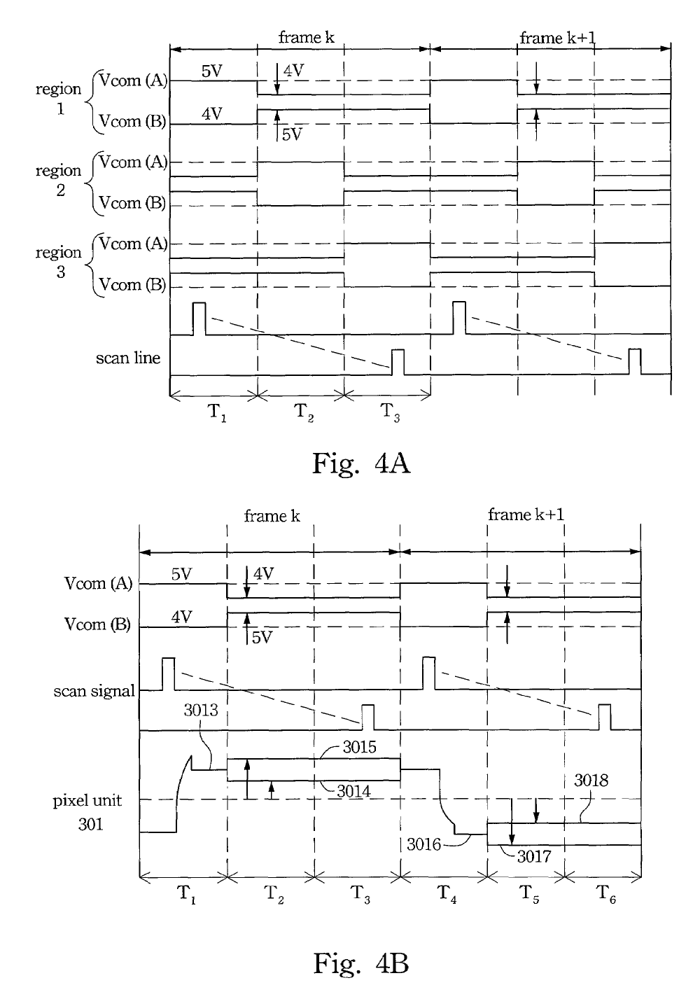

FIG. 4A illustrates a drive waveform for driving a liquid crystal display according to the first embodiment of the present invention. The drive voltage waveform for sequentially driving the first scan line to the last scan line is illustrated in this figure. Moreover, the scan lines of the liquid crystal display are divided into three regions, region 1, region 2 and region 3, in this embodiment. However, in other embodiments, the scan lines of the liquid crystal display also may be divided into more or less than three regions. In this embodiment, the drive voltage waveform applied to the common electrode V_{com}(A) and the common electrode V_{com}(B) in a frame is also divided into three time zones, T1, T2 and T3, to correspond to the divided regions in a liquid crystal display. The drive voltage of three time zones is sequentially applied to the three regions to drive the common electrode V_{com}(A) and the common electrode V_{com}(B). Accordingly, the scan lines in the region 1 are scanned in time zone T1. The scan lines in the region 2 are scanned in time zone T2. The scan lines in the region 3 are scanned in time zone T3.

In time zone T1, the scan signal scans the scan lines in region 1. A standard drive voltage is applied to the common electrode V_{com}(A) and the common electrode V_{com}(B). The pixel electrode Vₚₐ and the pixel electrode V_{pb} have the voltage transferred in the data line D. Therefore, the pixel electrode Vₚₐ and the pixel electrode V_{pb} have the same voltage. In time zone T2, the scan lines in region 1 are not scanned by the scan signal. The drive voltage applied to the common electrode V_{com}(A) and the common electrode V_{com}(B) changes to a tuned voltage. Therefore, the pixel electrode Vₚₐ and the pixel electrode V_{pb} have different voltages. In the time zone T3, the scan signal does not scan the scan lines in region 1 and the drive voltage applied to the common electrode V_{com}(A) and the common electrode V_{com}(B) keeps in the tuned voltage. Therefore, the pixel electrode Vₚₐ and the pixel electrode V_{pb} have the same voltages as in the time zone T2.

In time zone T1, the scan signal does not scan the scan lines in region 2. Therefore, the pixel electrode Vₚₐ and the pixel electrode V_{pb} have the same voltages as in the previous frame. That is that the pixel electrode Vₚₐ and the pixel electrode V_{pb} have different voltages. In time zone T2, the scan signal scans the scan lines in region 2. The drive voltage applied to the common electrode V_{com}(A) and the common electrode V_{com}(B) is the standard voltage. The pixel electrode Vₚₐ and the pixel electrode V_{pb} have the voltages transferred in the data line D. Therefore, the pixel electrode Vₚₐ and the pixel electrode V_{pb} have the same voltages. In time zone T3, the scan signal does not scan the scan lines in region 2. The drive voltage applied to the common electrode V_{com}(A) and the common electrode V_{com}(B) changes to a tuned voltage. Therefore, the pixel electrode Vₚₐ and the pixel electrode V_{pb} have different voltages.

In time zone T1, the scan signal does not scan the scan lines in region 3. Therefore, the pixel electrode Vₚₐ and the pixel electrode V_{pb} have the same voltages as in the previous frame. That is that the pixel electrode Vₚₐ and the pixel electrode V_{pb} have different voltages. In time zone T2, the scan signal does not scan the scan lines in region 3. The drive voltage applied to the common electrode V_{com}(A) and the common electrode V_{com}(B) keeps in the tuned voltage. Therefore, the pixel electrode Vₚₐ and the pixel electrode V_{pb} have the same voltages as in the time zone T1. In time zone T3, the scan signal scans the scan lines in region 3. The drive voltage applied to the common electrode V_{com}(A) and the common electrode V_{com}(B) is the standard voltage. The pixel electrode Vₚₐ and the pixel electrode V_{pb} have the voltages transferred in the data line D. Therefore, the pixel electrode Vₚₐ and the pixel electrode V_{pb} have the same voltages. In other words, according to the present invention, the pixel electrode Vₚₐ and the pixel electrode V_{pb} have different voltages in at least two thirds of the frame time.

FIG. 4B illustrates a drive waveform for driving the pixel units located in region 1 according to the first embodiment of the present invention. The drive waveform for driving other regions may be deduced by analogy. The drive signal of each scan line is a pulse. When scanning, the drive signal is sequentially transferred to these scan lines. Moreover, the drive waveform for driving the common electrode V_{com}(A) and the common electrode V_{com}(B) is a two-step type drive waveform. The standard voltage and the tuned voltage applied to the common electrode V_{com}(A) in the sub-pixel 3011 is 5 volt and 4 volt respectively. The standard voltage and the tuned voltage applied to the common electrode V_{com}(A) in the sub-pixel 3012 is 4 volt and 5 volt respectively.

Referring to FIGS. 3C and 4B, during the time segment t₁ in frame K, the scan lines in region 1 are scanned sequentially. The scan line G₁ is in a high voltage state. Therefore, the transistors Q₁ and Q₂ are turned on. In this case, the voltage in the data line D₁ may charge the liquid crystal capacitors C_{LC1} and C_{LC1} and the storage capacitors Cₛₜ₁ and Cₛₜ₂ through the transistors Q₁ and Q₂. At this time, the pixel electrode Vₚₐ and the pixel electrode V_{pb} in the sub-pixel 3011 and 3012 have the pixel voltage 3013 in the data line D₁.

During the time segment t₂ in frame K, the scan lines in region 1 have been scanned. Therefore, the scan line G₁ is in a low voltage state. The transistors Q₁ and Q₂ are turned off. At the start of time segment t₂, the pixel electrode Vₚₐ and the pixel electrode V_{pb} have the pixel voltage 3013 in the data line D₁. However, at the start of the time segment t₂, the voltage applied to the common electrode V_{com}(A) in the sub-pixel 3011 changes from 5 volts to 4 volts. Such voltage change may change the voltage in the pixel electrode Vₚₐ from voltage 3013 down to the voltage 3014 through the coupling effect of the storage capacitor Cₛₜ₁. Similarly, at the start of the time segment t₂, the voltage applied to the common electrode V_{com}(B) in the sub-pixel 3012 changes from 4 volts to 5 volts. Such voltage changes may change the voltage in the pixel electrode V_{pb} from voltage 3013 up to the voltage 3015 through the coupling effect of the storage capacitor Cₛₜ₂. Therefore, the pixel electrode Vₚₐ and the pixel electrode V_{pb} in the sub-pixel 3011 and 3012 have different voltages.

During the time segment t₃ in frame K, the scan lines in region 1 have been scanned. The scan line G₁ is in a low voltage state. The transistors Q₁ and Q₂ are turned off. Therefore, the pixel electrode Vₚₐ and the pixel electrode V_{pb} in the sub-pixel 3011 and 3012 have the pixel voltage as in the time segment t₂.

Next, during the time segment 4 in frame K+1, the scan lines in region 1 are scanned again. Therefore, the scan line G₁ is in a high voltage state. The voltage applied to the common electrode V_{com}(A) and V_{com}(B) is a standard voltage. The transistors Q₁ and Q₂ are turned on. In this case, the voltage in the data line D₁ may charge the liquid crystal capacitors C_{LC1} and C_{LC1} and the storage capacitors C_{St1} and Cₛₜ₂ through the transistors Q₁ and Q₂. The data transferred in the Data line is reversed from frame K to frame K+1. At this time, the pixel electrode Vₚₐ and the pixel electrode V_{pb} in the sub-pixel 3011 and 3012 have the pixel voltage 3016 in the data line D₁.

During the time segment t₅ in frame K+1, the scan lines in region 1 have been scanned. Therefore, the scan line G₁ is in a low voltage state. The transistors Q₁ and Q₂ are turned off. At the start of the time segment t₅, the pixel electrode Vₚₐ and the pixel electrode V_{pb} have the pixel voltage 3016 in the data line D₁. However, at the start of the time segment t₅, the voltage applied to the common electrode V_{com}(A) in the sub-pixel 3011 changes from 5 volts to 4 volts. Such voltage changes may change the voltage in the pixel electrode Vₚₐ from voltage 3016 down to the voltage 3017 through the coupling effect of the storage capacitor Cₛₜ₁. Similarly, at the start of the time segment t₅, the voltage applied to the common electrode V_{com}(B) in the sub-pixel 3012 changes from 4 volts to 5 volts. Such voltage changes may change the voltage in the pixel electrode V_{pb} from voltage 3016 up to the voltage 3018 through the coupling effect of the storage capacitor Cₛₜ₂. Therefore, the pixel electrode Vₚₐ and the pixel electrode V_{pb} in the sub-pixel 3011 and 3012 have different voltages.

During the time segment t₆ in frame K+1, the scan lines in region 1 are scanned. The scan line G₁ is in a low voltage state. The transistors Q₁ and Q₂ are turned off. Therefore, the pixel electrode Vₚₐ and the pixel electrode V_{pb} in the sub-pixel 3011 and 3012 have the pixel voltage as in the time segment t₅.

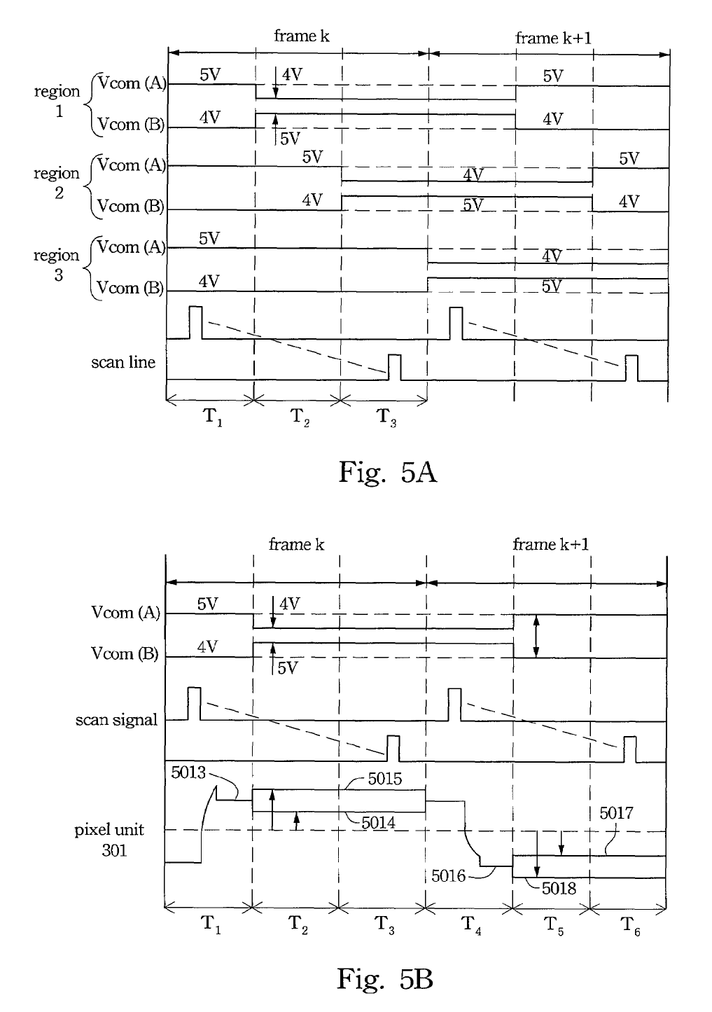

FIG. 5A illustrates a drive waveform for driving a liquid crystal display according to the second embodiment of the present invention. The drive voltage waveform for sequentially driving the first scan line to the last scan line is illustrated in FIG. 5A. Moreover, the scan lines of the liquid crystal display are divided into three regions, region 1, region 2 and region 3, in this embodiment. However, in other embodiments, the scan lines of the liquid crystal display may also be divided into more or less than three regions. In this embodiment, the drive voltage waveform applied to the common electrode V_{com}(A) and the common electrode V_{com}(B) in a frame is also divided into three time zones, T1, T2 and T3, to correspond to the divided regions in a liquid crystal display. Accordingly, the scan lines in the region 1 are scanned in time zone T1. The scan lines in the region 2 are scanned in time zone T2. The scan lines in the region 3 are scanned in time zone T3. The main difference between the first embodiment and the second embodiment is the drive voltage waveform for the common electrode V_{com}(A) and the common electrode V_{com}(B). In this embodiment, the tuned voltage in the frame k is the standard voltage in the frame k+1. The standard voltage in the frame k is the tuned voltage in the frame k+1.

In time zone T1, the scan signal scans the scan lines in region 1. The pixel electrode Vₚₐ and the pixel electrode V_{pb} have the voltage transferred in the data line D. Therefore, the pixel electrode Vₚₐ and the pixel electrode V_{pb} have the same voltage. In time zone T2, the scan signal does not scan the scan lines in region 1. The drive voltage applied to the common electrode V_{com}(A) and the common electrode V_{com}(B) changes to a tuned voltage. Therefore, the pixel electrode Vₚₐ and the pixel electrode V_{pb} have different voltages. In time zone T3, the scan signal does not scan the scan lines in region 1 and the drive voltage applied to the common electrode V_{com}(A) and the common electrode V_{com}(B) keeps in the tuned voltage. Therefore, the pixel electrode Vₚₐ and the pixel electrode V_{pb} have the same voltages as in the time zone T2.

In time zone T1, the scan signal does not scan the scan lines in region 2. Therefore, the pixel electrode Vₚₐ and the pixel electrode V_{pb} have different voltages. In time zone T2, the scan signal scans the scan lines in region 2. The drive voltage applied to the common electrode V_{com}(A) and the common electrode V_{com}(B) is the standard voltage. The pixel electrode Vₚₐ and the pixel electrode V_{pb} have the voltages transferred in the data line D. Therefore, the pixel electrode Vₚₐ and the pixel electrode V_{pb} have the same voltages. In time zone T3, the scan signal does not scan the scan lines in region 2. The drive voltage applied to the common electrode V_{com}(A) and the common electrode V_{com}(B) changes to a tuned voltage. Therefore, the pixel electrode Vₚₐ and the pixel electrode V_{pb} have different voltages.

In time zone T1, the scan signal does not scan the scan lines in region 3. Therefore, the pixel electrode Vₚₐ and the pixel electrode V_{pb} have different voltages. In time zone T2, the scan signal does not scan the scan lines in region 3. The drive voltage applied to the common electrode V_{com}(A) and the common electrode V_{com}(B) keeps in the tuned voltage. Therefore, the pixel electrode Vₚₐ and the pixel electrode V_{pb} have the same voltages as in the time zone T1. In time zone T3, the scan signal does not scan the scan lines in region 3. The drive voltage applied to the common electrode V_{com}(A) and the common electrode V_{com}(B) is the standard voltage. The pixel electrode Vₚₐ and the pixel electrode V_{pb} have the voltages transferred in the data line D. Therefore, the pixel electrode Vₚₐ and the pixel electrode V_{pb} have the same voltages. In other words, according to the present invention, the pixel electrode Vₚₐ and the pixel electrode V_{pb} have different voltages in at least ⅔ frame time.

FIG. 5B illustrates a drive waveform for driving the pixel units located in the region 1 according to the second embodiment of the present invention. The drive waveform for driving other regions may be deduced by analogy. The drive signal of each scan line is a pulse. When scanning, the drive signal is sequentially transferred to these scan lines. Moreover, the drive waveform for driving the common electrode V_{com}(A) and the common electrode V_{com}(B) is a two-step type drive waveform whose voltage level state is 5 volts and 4 volts.

Referring to FIGS. 3C and 5B, during the time segment t₁ in frame K, the scan lines in region 1 are scanned sequentially. The scan line G₁ is in a high voltage state. Therefore, the transistors Q₁ and Q₂ are turned on. In this case, the voltage in the data line D₁ may charge the liquid crystal capacitors C_{LC1} and C_{LC1} and the storage capacitors Cₛₜ₁ and Cₛₜ₂ through the transistors Q₁ and Q₂. At this time, the pixel electrode Vₚₐ and the pixel electrode V_{pb} in the sub-pixel 3011 and 3012 have the pixel voltage 5013 in the data line D₁.

During the time segment t₂ in frame K, the scan lines in region 1 have been scanned. Therefore, the scan line G₁ is in a low voltage state. The transistors Q₁ and Q₂ are turned off. At the start of the time segment t₂, the pixel electrode Vₚₐ and the pixel electrode V_{pb} have the pixel voltage 5013 in the data line D₁. However, at the start of the time segment t₂, the voltage applied to the common electrode V_{com}(A) in the sub-pixel 3011 changes from 5 volts to 4 volts. Such voltage changes may change the voltage in the pixel electrode Vₚₐ from voltage 5013 down to the voltage 5014 through the coupling effect of the storage capacitor Cₛₜ₁. Similarly, at the start of the time segment t₂, the voltage applied to the common electrode V_{com}(B) in the sub-pixel 3012 changes from 4 volts to 5 volts. Such voltage changes may change the voltage in the pixel electrode V_{pb} from voltage 5013 up to the voltage 5015 through the coupling effect of the storage capacitor Cₛₜ₂. Therefore, the pixel electrode Vₚₐ and the pixel electrode V_{pb} in the sub-pixel 3011 and 3012 have different voltages.

During the time segment t₃ in frame K, the scan lines in region 1 have been scanned. The scan line G₁ is in a low voltage state. The transistors Q₁ and Q₂ are turned off. Therefore, the pixel electrode Vₚₐ and the pixel electrode V_{pb} in the sub-pixel 3011 and 3012 have the pixel voltage as in the time segment t₂.

Next, during the time segment 4 in frame K+1, the scan lines in region 1 are scanned again. Therefore, the scan line G₁ is in a high voltage state. The voltage applied to the common electrode V_{com}(A) and V_{com}(B) keeps in the voltage level of the time segment t₃ in frame K. The transistors Q₁ and Q₂ are turned on. In this case, the voltage in the data line D₁ may charge the liquid crystal capacitors C_{LC1} and C_{LC1} and the storage capacitors Cₛₜ₁ and Cₛₜ₂ through the transistors Q₁ and Q₂. The data transferred in the Data line is reversed from frame K to frame K+1. Therefore, the pixel electrode Vₚₐ and the pixel electrode V_{pb} in the sub-pixel 3011 and 3012 have the pixel voltage 5016 in the data line D₁.

During the time segment t₅ in frame K+1, the scan lines in region 1 have been scanned. Therefore, the scan line G₁ is in a low voltage state. The transistors Q₁ and Q₂ are turned off. At the start of the time segment t₅, the pixel electrode Vₚₐ and the pixel electrode V_{pb} have the pixel voltage 5016 in the data line D₁. However, at the start of the time segment t₅, the voltage applied to the common electrode V_{com}(A) in the sub-pixel 3011 changes from 4 volts to 5 volts. Such voltage changes may change the voltage in the pixel electrode Vₚₐ from voltage 5016 up to the voltage 5017 through the coupling effect of the storage capacitor Cₛₜ₁. Similarly, at the start of the time segment t₅, the voltage applied to the common electrode V_{com}(B) in the sub-pixel 3012 changes from 5 volts to 4 volts. Such voltage change may change the voltage in the pixel electrode V_{pb} from voltage 5016 down to the voltage 5018 through the coupling effect of the storage capacitor Cₛₜ₂. Therefore, the pixel electrode Vₚₐ and the pixel electrode V_{pb} in the sub-pixel 3011 and 3012 have different voltages.

During the time segment t₆ in frame K+1, the scan lines in region 1 have been scanned. The scan line G₁ is in a low voltage state. The transistors Q₁ and Q₂ are turned off. Therefore, the pixel electrode Vₚₐ and the pixel electrode V_{pb} in the sub-pixel 3011 and 3012 have the pixel voltage as in the time segment t₅. Therefore, according to the present invention, the pixel electrode Vₚₐ and the pixel electrode V_{pb} have different voltages during at least two thirds of the time frame.

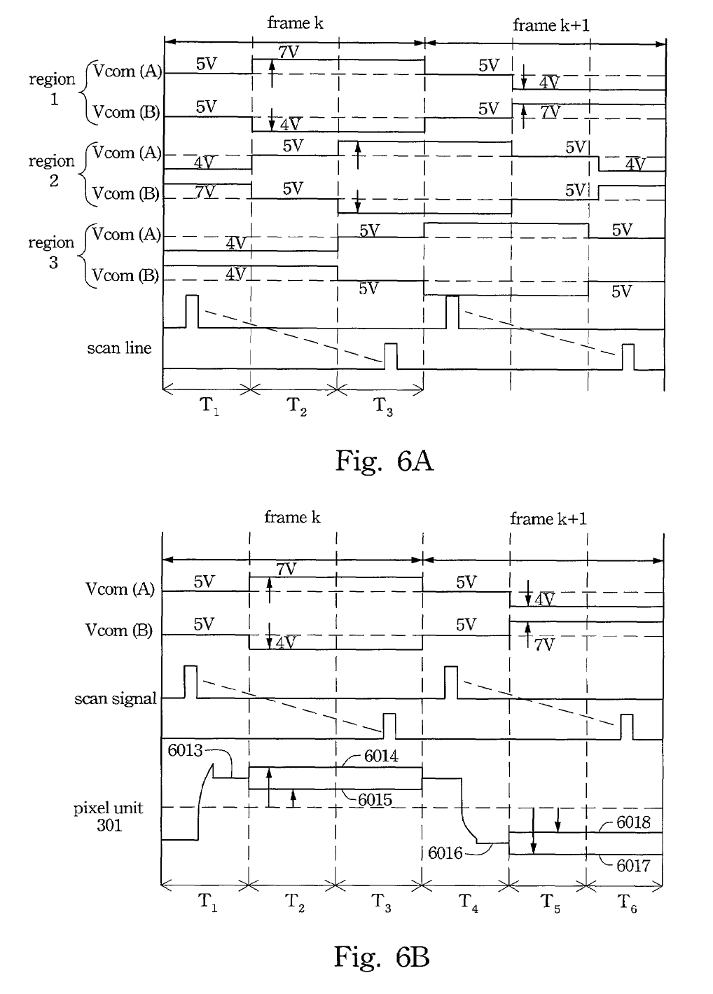

FIG. 6A illustrates a drive waveform for driving a liquid crystal display according to the third embodiment of the present invention. FIG. 6A illustrates the drive voltage waveform for sequentially driving the first scan line to the last scan line. Moreover, the scan lines of the liquid crystal display are divided into three regions, region 1, region 2 and region 3, in this embodiment. However, in other embodiments, the scan lines of the liquid crystal display may also be divided into more or less than three regions. In this embodiment, the drive voltage waveform applied to the common electrode V_{com}(A) and the common electrode V_{com}(B) in a frame is also divided into three time zones, T1, T2 and T3, to correspond to the divided regions in a liquid crystal display. Accordingly, the scan lines in the region 1 are scanned in time zone T1. The scan lines in the region 2 are scanned in time zone T2. The scan lines in the region 3 are scanned in time zone T3. The main difference between this embodiment and the first embodiment and the second embodiment is that a three-step drive voltage is used in this embodiment to drive the common electrode V_{com}(A) and the common electrode V_{com}(B). The three-step drive voltage includes three voltages, 4 volts, 5 volts and 6 volts. In this embodiment, the value of the drive voltage is switched to the standard voltage at the initial moment of each frame. Moreover, different tuned voltages are applied to the same pixel electrode between two adjacent frames.

In time zone T1, the scan signal scans the scan lines in region 1. The drive voltage applied to the common electrode V_{com}(A) and the common electrode V_{com}(B) is the standard voltage. The pixel electrode Vₚₐ and the pixel electrode V_{pb} have the voltage transferred in the data line D. Therefore, the pixel electrode Vₚₐ and the pixel electrode V_{pb} have the same voltage. In time zone T2, the scan signal does not scan lines in region 1. The drive voltage applied to the common electrode V_{com}(A) and the common electrode V_{com}(B) changes to a tuned voltage. Therefore, the pixel electrode Vₚₐ and the pixel electrode V_{pb} have different voltages. In time zone T3, the scan signal does not scan the scan lines in region 1 and the drive voltage applied to the common electrode V_{com}(A) and the common electrode V_{com}(B) keeps in the tuned voltage. Therefore, the pixel electrode Vₚₐ and the pixel electrode V_{pb} have the same voltages as in the time zone T2.

In time zone T1, the scan signal does not scan the scan lines in region 2. Therefore, the pixel electrode Vₚₐ and the pixel electrode V_{pb} have different voltages. In time zone T2, the scan signal does not scan the scan lines in region 2. The drive voltage applied to the common electrode V_{com}(A) and the common electrode V_{com}(B) is the standard voltage. The pixel electrode Vₚₐ and the pixel electrode V_{pb} have the voltages transferred in the data line D. Therefore, the pixel electrode Vₚₐ and the pixel electrode V_{pb} have the same voltages. In time zone T3, the scan signal does not scan the scan lines in region 2. The drive voltage applied to the common electrode V_{com}(A) and the common electrode V_{com}(B) changes to a tuned voltage. Therefore, the pixel electrode Vₚₐ and the pixel electrode V_{pb} have different voltages.

In the time zone T1, the scan signal does not scan the scan lines in region 3. Therefore, the pixel electrode Vₚₐ and the pixel electrode V_{pb} have different voltages. In time zone T2, the scan signal does not scan the scan lines in region 3. The drive voltage applied to the common electrode V_{com}(A) and the common electrode V_{com}(B) keeps in the tuned voltage. Therefore, the pixel electrode Vₚₐ and the pixel electrode V_{pb} have the same voltages as in the time zone T1. In time zone T3, the scan signal scans the scan lines in region 3. The drive voltage applied to the common electrode V_{com}(A) and the common electrode V_{com}(B) is the standard voltage. The pixel electrode Vₚₐ and the pixel electrode V_{pb} have the voltages transferred in the data line D. Therefore, the pixel electrode Vₚₐ and the pixel electrode V_{pb} have the same voltages. In other words, according to the present invention, the pixel electrode Vₚₐ and the pixel electrode V_{pb} have different voltages during at least two thirds of the time frame.

FIG. 6B illustrates a drive waveform for driving the pixel units located in region 1 according to the third embodiment of the present invention. The drive waveform for driving other regions may be deduced by analogy. The drive signal of each scan line is a pulse. When scanning, the drive signal is sequentially transferred to these scan lines. Moreover, the drive waveform for driving the common electrode V_{com}(A) and the common electrode V_{com}(B) is a three-step type drive waveform whose voltage level state is 4 volts, 5 volts and 7 volts.

Referring to FIGS. 3C and 6B, during the time segment t₁ in frame K, the scan lines in region 1 are scanned sequentially. The scan line G₁ is in a high voltage state. Therefore, the transistors Q₁ and Q₂ are turned on. In this case, the voltage in the data line D₁ may charge the liquid crystal capacitors C_{LC1} and C_{LC1} and the storage capacitors Cₛₜ₁ and Cₛₜ₂ through the transistors Q₁ and Q₂. At this time, the pixel electrode Vₚₐ and the pixel electrode V_{pb} in the sub-pixel 3011 and 3012 have the pixel voltage 6013 in the data line D₁.

During the time segment t₂ in frame K, the scan lines in region 1 have been scanned. Therefore, the scan line G₁ is in a low voltage state. The transistors Q₁ and Q₂ are turned off. At the start of the time segment t₂, the pixel electrode Vₚₐ and the pixel electrode V_{pb} have the pixel voltage 6013 in the data line D₁. However, at the start of the time segment t₂, the voltage applied to the common electrode V_{com}(A) in the sub-pixel 3011 changes from 5 volts to 7 volts. Such voltage changes may change the voltage in the pixel electrode Vₚₐ from voltage 6013 up to the voltage 6014 through the coupling effect of the storage capacitor Cₛₜ₁. Similarly, at the start of the time segment t₂, the voltage applied to the common electrode V_{com}(B) in the sub-pixel 3012 changes from 5 volts to 4 volts. Such voltage changes may change the voltage in the pixel electrode V_{pb} from voltage 6013 down to the voltage 6015 through the coupling effect of the storage capacitor Cₛₜ₂. Therefore, the pixel electrode Vₚₐ and the pixel electrode V_{pb} in the sub-pixel 3011 and 3012 have different voltages.

During the time segment t₃ in frame K, the scan lines in region 1 have been scanned. The scan line G₁ is in a low voltage state. The transistors Q₁ and Q₂ are turned off. Therefore, the pixel electrode Vₚₐ and the pixel electrode V_{pb} in the sub-pixel 3011 and 3012 have the same pixel voltage as in the time segment t₂.

Next, during the time segment t4 in frame K+1, the scan lines in region 1 are scanned again. Therefore, the scan line G₁ is in a high voltage state. The voltage applied to the common electrode V_{com}(A) and V_{com}(B) returns to the standard voltage level, 5 volts. Therefore, the transistors Q₁ and Q₂ are turned on. In this case, the voltage in the data line D₁ may charge the liquid crystal capacitors C_{LC1} and C_{LC1} and the storage capacitors Cₛₜ₁ and Cₛₜ₂ through the transistors Q₁ and Q₂. The data transferred in the Data line is reversed from frame K to frame K+1. Therefore, the pixel electrode Vₚₐ and the pixel electrode V_{pb} in the sub-pixel 3011 and 3012 have the pixel voltage 6016 in the data line D₁.

During the time segment t₅ in frame K+1, the scan lines in region 1 have been scanned. Therefore, the scan line G₁ is in a low voltage state. The transistors Q₁ and Q₂ are turned off. At the start of the time segment t₅, the pixel electrode Vₚₐ and the pixel electrode V_{pb} have the pixel voltage 6016 in the data line D₁. However, at the start of the time segment t₅, the voltage applied to the common electrode V_{com}(A) in the sub-pixel 3011 changes from 5 volts to 4 volts. Such voltage changes may change the voltage in the pixel electrode Vₚₐ from voltage 6016 down to the voltage 6017 through the coupling effect of the storage capacitor Cₛₜ₁. Similarly, at the start of the time segment t₅, the voltage applied to the common electrode V_{com}(B) in the sub-pixel 3012 changes from 5 volts to 7 volts. Such voltage changes may change the voltage in the pixel electrode V_{pb} from voltage 6016 up to the voltage 6018 through the coupling effect of the storage capacitor Cₛₜ₂. Therefore, the pixel electrode Vₚₐ and the pixel electrode V_{pb} in the sub-pixel 3011 and 3012 have different voltages.

During the time segment t₆ in frame K+1, the scan lines in region 1 have been scanned. The scan line G₁ is in a low voltage state. The transistors Q₁ and Q₂ are turned off. Therefore, the pixel electrode Vₚₐ and the pixel electrode V_{pb} in the sub-pixel 3011 and 3012 have the pixel voltage as in the time segment t₅. Therefore, according to the present invention, the pixel electrode Vₚₐ and the pixel electrode V_{pb} have different voltages during at least two thirds of the time frame.

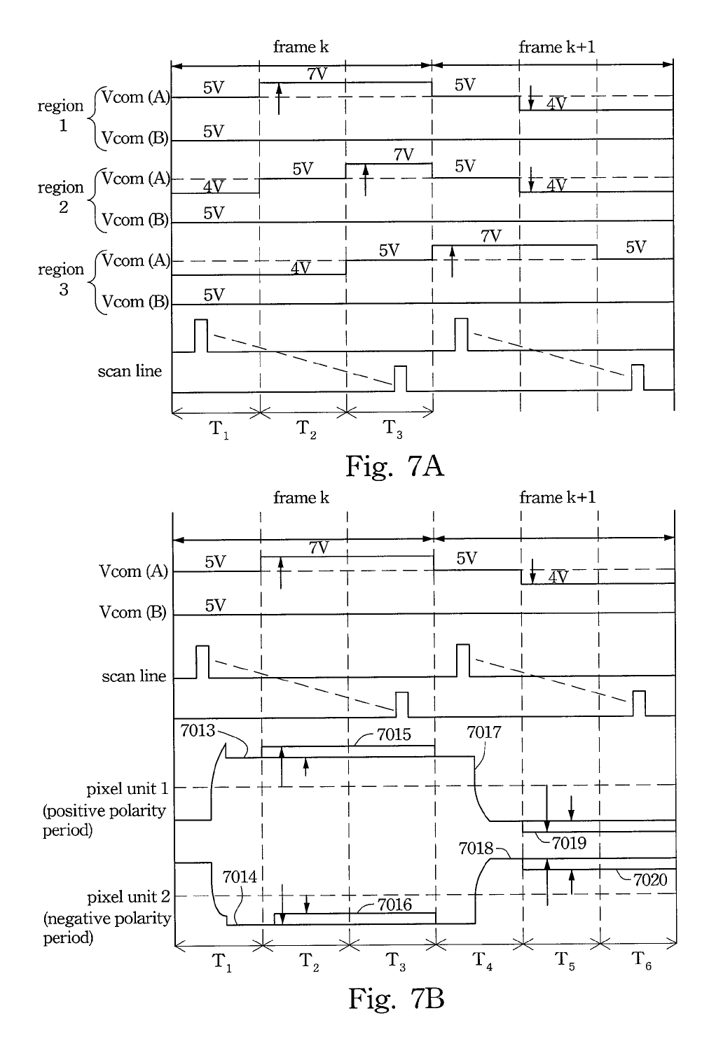

FIG. 7A illustrates a drive waveform for driving a liquid crystal display according to the fourth embodiment of the present invention. FIG. 7A illustrates the drive voltage waveform for sequentially driving the first scan line to the last scan line. Moreover, the scan lines of the liquid crystal display are divided into three regions, region 1, region 2 and region 3, in this embodiment. However, in other embodiments, the scan lines of the liquid crystal display may also be divided into more or less than three regions. In this embodiment, the drive voltage waveform applied to the common electrode V_{com}(A) and the common electrode V_{com}(B) in a frame is also divided into three time zones, T1, T2 and T3, to correspond to the divided regions in a liquid crystal display. Accordingly, the scan lines in the region 1 are scanned in time zone T1. The scan lines in region 2 are scanned in time zone T2. The scan lines in the region 3 are scanned in time zone T3. The main difference between this embodiment and the foregoing embodiments is that the drive voltage applied to the common electrode V_{com}(B) is 5 volts.

In the time zone T1, the scan signal scans the scan lines in region 1. The voltage applied to the common electrode V_{com}(A) is the standard voltage. The voltage applied to the common electrode V_{com}(B) is 5 volt. The pixel electrode Vₚₐ and the pixel electrode V_{pb} have the voltage transferred in the data line D. Therefore, the pixel electrode Vₚₐ and the pixel electrode V_{pb} have the same voltage. In time zone T2, the scan signal does not scan the scan lines in region 1. The voltage applied to the common electrode V_{com}(A) is changed to a tuned voltage. The voltage applied to the common electrode V_{com}(B) is 5 volts. Therefore, the pixel electrode Vₚₐ and the pixel electrode V_{pb} have different voltages. In time zone T3, the scan signal does not scan the scan lines in region 1 and the drive voltage applied to the common electrode V_{com}(A) and the common electrode V_{com}(B) keeps in the tuned voltage and 5 volts respectively. Therefore, the pixel electrode Vₚₐ and the pixel electrode V_{pb} have same voltages as in the time zone T2.

In time zone T1, the scan signal does not scan the scan lines in region 2. Therefore, the pixel electrode Vₚₐ and the pixel electrode V_{pb} have different voltages. In time zone T2, the scan signal scans the scan lines in region 2. The voltage applied to the common electrode V_{com}(A) and the common electrode V_{com}(B) is 5 volts. The pixel electrode Vₚₐ and the pixel electrode V_{pb} have the voltages transferred in the data line D. Therefore, the pixel electrode Vₚₐ and the pixel electrode V_{pb} have the same voltages. In time zone T3, the scan signal does not scan the scan lines in region 2. The voltage applied to the common electrode V_{com}(A) is changed to a tuned voltage. The voltage applied to the common electrode V_{com}(B) is 5 volts. Therefore, the pixel electrode Vₚₐ and the pixel electrode V_{pb} have different voltages.

In the time zone T1, the scan signal does not scan the scan lines in region 3. Therefore, the pixel electrode Vₚₐ and the pixel electrode V_{pb} have different voltages. In time zone T2, the scan signal does not scan the scan lines in region 3. The drive voltage applied to the common electrode V_{com}(A) and the common electrode V_{com}(B) keeps in the same voltage as in time zone T1. Therefore, the pixel electrode Vₚₐ and the pixel electrode V_{pb} have the same voltages as in the time zone T1. In time zone T3, the scan signal scans the scan lines in region 3. A voltage of 5 volts is applied to the common electrode V_{com}(A). A voltage of 5 volts is also applied to the common electrode V_{com}(B). Therefore, the pixel electrode Vₚₐ and the pixel electrode V_{pb} have the same voltages transferred in the data line D. Therefore, the pixel electrode Vₚₐ and the pixel electrode V_{pb} have the same voltages. In other words, according to the present invention, the pixel electrode Vₚₐ and the pixel electrode V_{pb} have different voltages during at least two thirds of the time frame.

FIG. 7B illustrates a drive waveform for driving the pixel units located in the region 1 according to the fourth embodiment of the present invention. The drive waveform for driving other regions may be deduced by analogy. The drive signal of each scan line is a pulse. When scanning, the drive signal is sequentially transferred to these scan lines. Moreover, the drive waveform for driving the common electrode V_{com}(A) is a three-step type drive waveform whose voltage level state is 4 volts, 5 volts and 7 volts. The drive waveform for driving the common electrode V_{com}(B) is a fixed voltage waveform whose voltage is 5 volts.

Typically, to prevent the liquid crystal molecule from being deflected in a fixed position, the voltage in the data line is changed between a positive polarity and a negative polarity. Moreover, the voltage for driving the common electrode V_{com}(A) in frame K always increases the pixel voltage of the pixel electrode Vₚₐ. Therefore, if the voltage change value in the data line in the positive polarity is same as that in the negative polarity, the voltage change value in the pixel electrode Vₚₐ in the positive polarity will be different from that in the negative polarity after the pixel electrode Vₚₐ is adjusted by the voltage in the common electrode V_{com}(A). Such voltage differences between the positive polarity and the negative polarity may cause the liquid crystal molecule to be deflected at a different angle, which reduces the display quality. Therefore, different voltages are provided to the data line in the positive polarity and in the negative polarity to generate the same voltage change value in the pixel electrode Vₚₐ.

Referring to FIGS. 3C and 7B, during the time segment t₁ in frame K, the scan lines in region 1 are scanned sequentially. The voltage applied to the common electrode V_{com}(A) and the common electrode V_{com}(B) is 5 volts. The scan line G₁ is in a high voltage state. Therefore, the transistors Q₁ and Q₂ are turned on. In this case, the voltage in the data line D₁ may charge the liquid crystal capacitors C_{LC1} and C_{LC1} and the storage capacitors Cₛₜ₁ and Cₛₜ₂ through the transistors Q₁ and Q₂. At this time, the pixel electrode Vₚₐ and the pixel electrode V_{pb} in the sub-pixel 3011 and 3012 have the pixel voltage 7013 in the data line D₁.

In this embodiment, to prevent the pixel electrode from having different voltage changes during the periods of positive polarity and negative polarity, different voltages are provided to the data line during the period of positive polarity and during the period of negative polarity to generate the same voltage change value in the pixel electrode. Therefore, during the positive polarity period, +127 gray level voltage 7013 is provided to the data line. In the negative polarity period, −150 gray level voltage 7014 is provided to the data line.

During the time segment t₂ in frame K, the scan lines in region 1 have been scanned. Therefore, the scan line G₁ is in a low voltage state. The transistors Q₁ and Q₂ are turned off. At the start of the time segment t₂, the pixel electrode Vₚₐ and the pixel electrode V_{pb} have the pixel voltage in the data line D₁. According to this embodiment, in the positive polarity period, the pixel voltage of the pixel electrode Vₚₐ and the pixel electrode V_{pb} is +127 gray level voltage 7013. In the negative polarity period, the pixel voltage of the pixel electrode Vₚₐ and the pixel electrode V_{pb} is −150 gray level voltage 7014. However, at the start of the time segment t₂, the voltage applied to the common electrode V_{com}(A) in the sub-pixel 3011 changes from 5 volts to 7 volts. Such voltage changes may change the voltage in the pixel electrode Vₚₐ. The voltage changed from +127 gray level voltage 7013 to the voltage 7015 in the positive polarity period, and is changed form −150 gray level voltage 7014 to the voltage 7016 in the negative polarity period. On the other hand, at the start of the time segment t₂, the voltage applied to the common electrode V_{com}(B) in the sub-pixel 3012 keeps in the 5 volts. That is that the voltage in the pixel electrode V_{pb} is unchanged. Therefore, the voltage is +127 gray level voltage 7013 in the positive polarity period, and −150 gray level voltage 7014 in the negative polarity period. Therefore, the pixel electrode Vₚₐ and the pixel electrode V_{pb} in the sub-pixel 3011 and 3012 have different voltages.

During the time segment t₃ in frame K, the scan lines in region 1 have been scanned. The scan line G1 is in a low voltage state. The transistors Q₁ and Q₂ are turned off. Therefore, the pixel electrode Vₚₐ and the pixel electrode V_{pb} in the sub-pixel 3011 and 3012 have the pixel voltage as in the time segment t₂.

Next, during the time segment 4 in frame K+1, the scan lines in region 1 are scanned again. Therefore, the scan line G₁ is in a high voltage state. The voltage applied to the common electrode V_{com}(A) and V_{com}(B) returns to the standard voltage level, 5 volt. Therefore, the transistors Q₁ and Q₂ are turned on. In this case, the voltage in the data line D₁ may charge the liquid crystal capacitors C_{LC1} and C_{LC1} and the storage capacitors Cₛₜ₁ and Cₛₜ₂ through the transistors Q₁ and Q₂. Therefore, the pixel electrode Vₚₐ and the pixel electrode V_{pb} in the sub-pixel 3011 and 3012 have the pixel voltage in the data line D₁. According to this embodiment, the voltage is −127 gray level voltage 7017 in the positive polarity period, and is +150 gray level voltage 7018 in the negative polarity period.

During the time segment t₅ in frame K+1, the scan lines in region 1 have been scanned. Therefore, the scan line G₁ is in a low voltage state. The transistors Q₁ and Q₂ are turned off. At the start of the time segment t₅, the pixel electrode Vₚₐ and the pixel electrode V_{pb} have the pixel voltage in the data line D₁. However, at the start of the time segment t₅, the voltage applied to the common electrode V_{com}(A) in the sub-pixel 3011 changes from 5 volts to 4 volts. Such voltage changes may change the voltage in the pixel electrode Vₚₐ. The voltage change is changed form −127 gray level voltage 7017 to the voltage 7019 in the positive polarity period, and is changed form +150 gray level voltage 7018 to the voltage 7020 in the negative polarity period. Similarly, at the start of the time segment t₅, a constant voltage of 5 volts is applied to the common electrode V_{com}(B) in the sub-pixel 3012. That is that the voltage in the pixel electrode V_{pb} does not changed. Therefore, the voltage is −127 gray level voltage 7017 in the positive polarity period, and is +150 gray level voltage 7018 in the negative polarity period. Therefore, the pixel electrode Vₚₐ and the pixel electrode V_{pb} in the sub-pixel 3011 and 3012 have different voltages.

During the time segment t₆ in frame K+1, the scan lines in region 1 have been scanned. The scan line G₁ is in a low voltage state. The transistors Q₁ and Q₂ are turned off. Therefore, the pixel electrode Vₚₐ and the pixel electrode V_{pb} in the sub-pixel 3011 and 3012 have the pixel voltage as in the time segment t₅. Therefore, according to the present invention, the pixel electrode Vₚₐ and the pixel electrode V_{pb} have different voltages in at least ⅔ frame time.

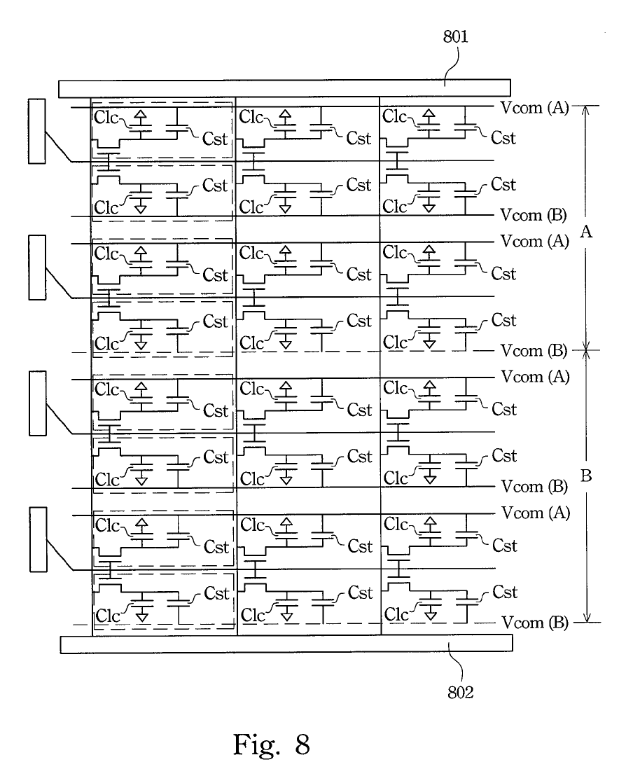

It is noticed that the foregoing drive method can be used in a dual drive LCD. For example, FIG. 8 illustrates a schematic diagram of a liquid crystal display using dual driving technology. In this embodiment, the drive voltages for scan lines in the region A and in the region B are provided respectively. That is that the drive voltage source for scan lines in the region A is isolated to that in the region B. Moreover, the drive IC 801 provides the voltage to the data lines in region A. The drive IC 802 provides the voltage to the data lines in region B.

According to this embodiment, the scan lines in region A and region B are also separated into several regions. The common electrodes located among theses several regions are sequentially supplied voltages by time. Due to the drive voltage source for scan lines in the region A isolated to that in the region B, the time for driving the scan lines may be reduced to increase the time for the common electrodes to adjust the voltages in the pixel electrodes.

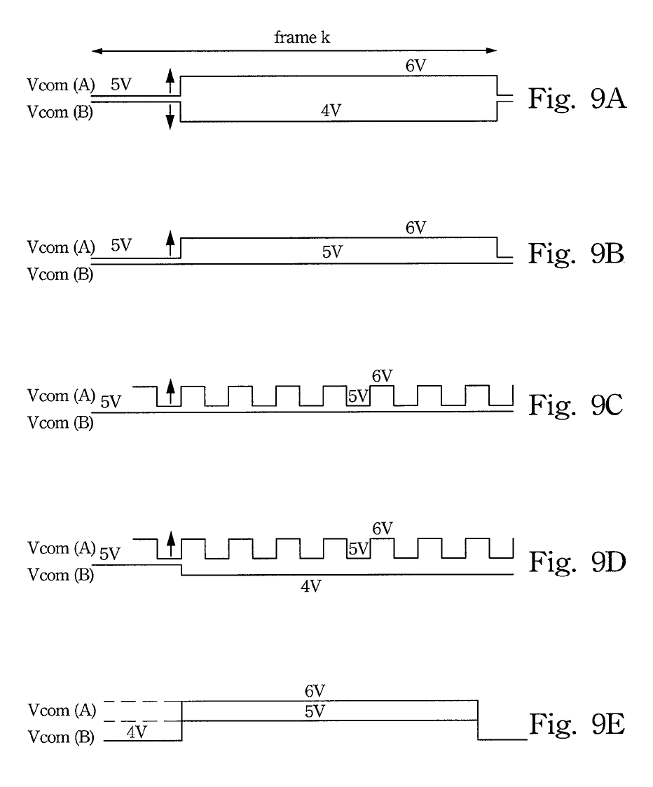

On the other hand, other types of the drive voltage waveform for the common electrodes also can be used in the present invention. FIG. 9A to FIG. 9E illustrate the waveforms for driving a liquid crystal display according to the present invention.

In FIG. 9A, the voltage applied to the common electrode V_{com}(A) is switched between 5 volts and 6 volts. The voltage applied to the common electrode V_{com}(B) is switched between 5 volt and 4 volt.

In FIG. 9B, the voltage applied to the common electrode V_{com}(A) is switched between 5 volts and 6 volts. The voltage applied to the common electrode V_{com}(B) keeps in 5 volts.

In FIG. 9C, the voltage waveform applied to the common electrode V_{com}(A) is a square voltage waveform whose voltage is switched between 5 volts and 6 volts. The voltage applied to the common electrode V_{com}(B) keeps in 5 volts. In this embodiment, the optical characteristic is related to the root mean square voltage. In another embodiment, the voltage applied to the common electrode V_{com}(B) is switched between 5 volts and 4 volts. The voltage applied to the common electrode V_{com}(B) is switched between 5 volt and 4 volt as shown in the FIG. 9D.

In FIG. 9E, the voltage applied to the common electrode V_{com}(A) is switched between 4 volts and 6 volts. The voltage applied to the common electrode V_{com}(B) is switched between 4 volts and 5 volts.

Accordingly, a pixel unit in the present invention is divided into two sub-pixels. Each sub-pixel includes a thin film transistor, a liquid crystal capacitor and a storage capacitor. The storage capacitors in the two sub-pixels are coupled to different common electrodes respectively. A tuned voltage is applied to one of the two common electrodes to change the pixel electrode voltage. Therefore, different voltages exist in the two pixel electrodes to compensate to each other to release the color shift phenomenon.

As is understood by a person skilled in the art, the foregoing descriptions of the preferred embodiment of the present invention are an illustration of the present invention rather than a limitation thereof. Various modifications and similar arrangements are included within the spirit and scope of the appended claims. The scope of the claims should be accorded to the broadest interpretation so as to encompass all such modifications and similar structures. While a preferred embodiment of the invention has been illustrated and described, it will be appreciated that various changes can be made therein without departing from the spirit and scope of the invention.

What is claimed is:

1. A drive method for driving a liquid crystal display, wherein the liquid crystal display includes a pixel structure that is divided into N regions, each region includes a plurality of scan lines, a plurality of data lines, and a plurality of first and second common electrodes alternately arranged with the scan lines, wherein the data lines and the scan lines define a plurality of pixel units, each pixel unit includes a first sub-pixel having a first transistor and a first storage capacitor coupling with the first common electrode and a second sub-pixel having a second transistor and a second storage capacitor coupling with the second common electrode, the method comprising:
providing a scan signal to scan the scan lines sequentially to turn on the first transistors and the second transistors in the pixel units;
providing gray-level signals to the data lines to write the gray level signals to the first storage capacitors through the first transistors to form first pixel voltages and to write the gray level signals to the second storage capacitors through the second transistors to form second pixel voltages; and
providing a first signal to the first common electrodes in the m^{th} region and providing a second signal to the second common electrodes in the m^{th} region when the scan lines in the m^{th} region have been scanned, m=1 . . . N, wherein the first signal changes the first pixel voltages through the first storage capacitors and the second signal changes the second pixel voltages through the second storage capacitors.

2. The drive method of claim 1, wherein the scan signal is a pulse signal.

3. The drive method of claim 1, wherein both the first signal and the second signal are two-step signals.

4. The drive method of claim 1, wherein the first signal includes a first voltage and a second voltage and the second signal includes a third voltage and a fourth voltage.

5. The drive method of claim 4, wherein after the scan lines in the m^{th} region have been scanned, the first signal is switched from the first voltage to the second voltage and the second signal is switched from the third voltage to the fourth voltage.

6. The drive method of claim 1, wherein both the first signal and the second signal are three-step signals.

7. The drive method of claim 6, wherein the first signal includes a first voltage, a second voltage and a third voltage and the second signal includes a fourth voltage, a fifth voltage and a sixth voltage.

8. The drive method of claim 7, wherein in a frame, after the scan lines in the m^{th} region have been scanned, the first signal is switched from the first voltage to the second voltage and the second signal is switched from the fourth voltage to the fifth voltage, and in next frame, after the scan lines in the m^{th} region have been scanned, the first signal is switched from the first voltage to the third voltage and the second signal is switched from the fourth voltage to the sixth voltage.

9. The drive method of claim 1, wherein the first signal is a three-step signal and the second signal is a fixed voltage signal.

10. The drive method of claim 9, wherein the first signal includes a first voltage, a second voltage and a third voltage.

11. The drive method of claim 7, wherein in a frame, after the scan lines in the m^{th} region have been scanned, the first signal is switched from the first voltage to the second voltage, and in next frame, after the scan lines in the m^{th} region have been scanned, the first signal is switched from the first voltage to the third voltage.

12. The drive method of claim 1, wherein providing gray-level signals to the data lines further comprises setting a first gray-level signal in a positive polarity period and setting a second gray-level signal in a negative polarity period.

13. The drive method of claim 1, wherein the pixel structure that is divided into N regions is further divided into first group and second group.

14. The drive method of claim 13, wherein different data line ICs are used to provide data to the first group and the second group respectively

15. The drive method of claim 1, wherein the first signal is a two-step signal and the second signal is a fixed voltage signal.

16. The drive method of claim 1, wherein the first signal is a two-step signal and the second signal is a square wave signal.

17. The drive method of claim 1, wherein the first signal is a square wave signal and the second signal is a fixed voltage signal.

18. The drive method of claim 1, wherein the first signal is selected from the group consisting of a fixed voltage signal, a square wave signal, a two-step signal and a three-step signal.

19. The drive method of claim 1, wherein the second signal is selected from the group consisting of a fixed voltage signal, a square wave signal, a two-step signal and a three-step signal.
